(19) United States
(12) Patent Application Publication
(10) Pub. No.: US 2004/0148295 A1
(43) Pub. Date: Jul. 29, 2004

(54) Device and method for identifying a package recipient

(76) Inventor: John Stevens, Toronto (CA)

Correspondence Address: MCGINN & GIBB, PLLC, 8321 OLD COURTHOUSE ROAD, SUITE 200, VIENNA, VA, 22182-3817, US

(21) Appl. No.: 10/608,417

(22) Filed: Jun. 30, 2003

Related U.S. Application Data
(60) Provisional application No. 60/392,263, filed on Jul. 1, 2002.

(51) Int. Cl. G06F 17/00

(52) U.S. Cl. 707/100

(57) ABSTRACT

A method for identifying a package recipient includes delivering a package to a recipient, and recording at least one of the recipient's voice and the recipient's image. The recording may analyzed (e.g., reproduced) to identify a package recipient.

### CROSS REFERENCE TO RELATED APPLICATIONS

This Application claims priority from U. S. Provisional Application No. 60/392,263, METHOD AND DEVICE FOR IDENTIFYING A PACKAGE RECIPIENT, which was filed on Jul. 1, 2002, assigned to the present assignee, and is incorporated herein by reference.

### BACKGROUND OF THE INVENTION

1. Field of the Invention

The present invention relates to a device and method for identifying a package (e.g., courier package) recipient, and more particularly, to a method and device for identifying a courier package recipient which may provide proof of delivery and which may utilize an electronic (e.g., voice and/or image) recording.

2. Description of the Related Art

Conventional package delivery methods require the delivery person to transport the package to the destination, confirm the correct identity of the recipient, and have the recipient sign a form (e.g., electronic signature line) to verify that the recipient has received the package. Alternatively, the delivery person may punch the recipient's name and time of delivery on a keypad to verify delivery.

However, such conventional systems are subject to many errors. For example, the handwriting of the recipient is often illegible. Further, keypad-entered names are often subject to typographical errors so that such delivery information is often incomplete or inaccurate.

Further, such methods are incapable of providing a secure package delivery. For example, suppose a courier using such conventional methods is tasked with delivering a package containing a passport from the Immigration and Naturalization Service (INS) to the home of “John Smith”. When the courier arrives at the home, the courier will likely ask for “John Smith” and present the package to anyone who responds in the affirmative. The courier will then ask that the person accepting the package to sign a sheet to provide proof of delivery.

Therefore, it would be easy for a person other than “John Smith” (i.e., an improper recipient) to accept an take possession of such important delivery items. Moreover, even if it is later determined that the person who accepted the package was an improper recipient (e.g., a thief), the only way of identifying the improper recipient is based the memory of the delivery person. Since delivery persons may make dozens of deliveries in a single day, it is unlikely that the delivery person will remember the face, voice, build, clothes or any other characteristic of the improper recipient that would help to identify and capture the recipient. As a result, there is little chance that such an improper recipient will ever be caught and the package recovered, which results in little disincentive to attempt to improperly (e.g., fraudulently) take possession of a package from a delivery service.

Therefore, such conventional methods of delivering packages involve little security and are, therefore, especially inappropriate for packages requiring at least some degree of security, such as sensitive documents, legal documents, checks or other valuable items.

### SUMMARY OF THE INVENTION

In view of the foregoing and other problems, disadvantages, and drawbacks of the conventional methods and structures, a purpose of the present invention is to provide a device and method for identifying a package recipient which may provide proof of delivery and which may utilize an electronic (e.g., voice and or image) recording.

The present invention includes an inventive method for identifying a package recipient. The inventive method includes delivering a package to a recipient, and recording at least one of said recipient's voice and said recipient's image. The method may further include analyzing the recorded identification data (e.g., reproducing and comparing the recording) in order to identify a package recipient and/or provide proof of delivery. For example, identifying a package recipient and providing proof of delivery may be performed in real time.

For example, the recipient's voice may be recorded in a digital audio file such as a WAV file. Further, the recipient's image may be recorded in a digital image file (e.g., a JPEG file, MPEG file, PDF file and TIFF file). Further, the image may include a still image and/or a video image.

The inventive method may use, for example, a handheld device and include delivering a package to said recipient, picking up at least one of a recipient voice and a recipient image using the handheld device, the at least one of said recipient voice and the recipient image being transduced into an electrical identification signal using the handheld device, inputting at least one of delivery data and recipient data into the handheld device; and storing at least one the delivery data, the recipient data and the electrical identification signal in the handheld device.

Another aspect of the present invention includes a method for identifying a package recipient which includes generating a digital identification signal for the recipient using an identification pickup device, inputting delivery data; and storing the identification signal and the delivery data.

Another aspect of the present invention includes a device for identifying a package recipient. The device includes an identification pickup device (e.g., an audio pickup device and/or an image pickup device) for generating a digital identification signal for the recipient, an input device for inputting delivery data, and a memory device for storing the identification signal and the delivery data.

Further, the identification pickup device and the input device may include the same device. In addition, the digital identification signal may include one of a digital voice signal and a digital image signal.

More specifically, the identification pickup device may include a microphone and the digital identification signal may include a digital audio signal. In addition, the identification pickup device may include an image pickup device and the digital identification signal may include a digital image signal.

The inventive device may also include a user switch for activating and deactivating the identification pickup device. The inventive device may also include a display device for displaying a representation of the digital identification signal. The inventive device may also include a processor for processing data and instructions, and a transceiver for wirelessly communicating data (e.g., the digital identification signal) to a remote database.

Further, the input device may include an alphanumeric keypad. The device may also include a signature pickup device for picking up a recipient's signature and transducing the signature into an electronic signature signal. In this case, the memory device may also store the electronic signature signal.

In addition, the present invention includes a programmable storage medium tangibly embodying a program of machine-readable instructions executable by a digital processing apparatus to perform the inventive method.

With its unique and novel aspects, the present invention provides a method and device for identifying a courier package recipient and verifying delivery which may utilize an electronic (e.g., voice and/or image) recording. Specifically, the present invention provide a more reliable way of identifying a package recipient and/or providing proof of delivery.

### BRIEF DESCRIPTION OF THE DRAWINGS

The foregoing and other purposes, aspects and advantages will be better understood from the following detailed description of embodiments of the invention with reference to the drawings, in which:

FIG. 1 is a flow chart illustrating an inventive method 100 for identifying a package recipient according to an exemplary aspect of the present invention;

FIGS. 2A-2C illustrate an inventive device 200 for identifying a package recipient, including a voice recording device (e.g., a microphone), according to an exemplary aspect of the present invention;

FIGS. 3A-3H illustrate an inventive device 200 for identifying a package recipient, including an image recording device (e.g., camera), according to an exemplary aspect of the present invention; and

FIG. 4 provides a detailed illustration of an inventive device 200 according to an exemplary aspect of the present invention.

### DETAILED DESCRIPTION OF THE EXEMPLARY EMBODIMENTS OF THE INVENTION

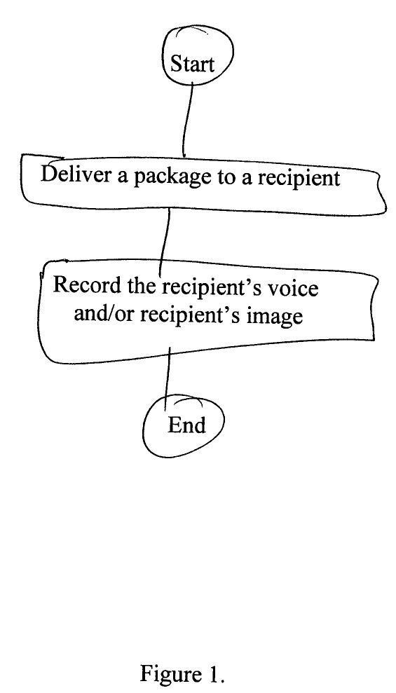

Referring now to the drawings, FIG. 1 is a flow chart illustrating an inventive method 100 for identifying a package (e.g., courier package) recipient and/or providing proof of delivery (POD) according to the present invention.

As shown in FIG. 1, the inventive method 100 includes delivering (110) a package to a recipient, and recording (120) the recipient's voice and/or the recipient's image (e.g., a visual image). The inventive method 100 may also include, for example, reproducing the recording to identify the package recipient and/or provide proof of delivery (POD).

In general, the inventive method 100 may record a recipient's voice or image (e.g., still or moving (e.g., video) image). Thus, the inventive method 100 may confirm proof of delivery for the courier, the sender and the addressee/recipient. Further, the inventive method 100 may identify the person who accepts the delivery of a package, without relying on potentially illegible handwriting signatures, or keypad-entered names (as found in conventional courier handheld devices which are used, for example, by couriers such as UPS, Federal Express, Purolator).

More specifically, the inventive method may include, for example, recording the recipient's voice on the memory of the courier/delivery personnel's handheld electronic device. For example, the recipient's voice may be stored in the form of an electronic (e.g., digital) voice file.

Additionally, the receiving party's voice can be analyzed (spectral analysis) and a digital voice-print can be made. This information can then be stored and downloaded to the Courier truck computer, directly to the courier's network via wireless application protocol (WAP) modem, or to the recipient, either by email or on the Courier's Website.

Specifically, the voice can be stored in a digital audio file in a file format for storing digital audio (waveform) data (e.g., a WAV file). If Proof of Delivery (POD) information is required, the shipper or addressee can request the digital audio file of the person who accepted delivery to track who accepted “signed for it”. Therefore, the sender may almost immediately be able to verify that the intended recipient received the sender's package.

In addition to the voice recording, or alternatively thereto, the inventive method 100 may include recording the recipient's visual image. In other words, either separately or in combination with capturing the recipient's Audio WAV file, the inventive method 100 may obtain a still image photograph or moving video image (e.g., a digital image) of the recipient. The image (e.g., still image or video) file may be compressed or non-compressed and may be recorded in any one or more of numerous formats including, for example, JPEG, MPEG, PDF or TIFF format.

Further, the image file can be used in the same way as the audio file described previously to create a verifiable proof of delivery to the photographed recipient. The sender could request photo confirmation for Proof of Delivery (POD). Like the voice recording, the image recording may be used instead of or in combination with a hand written signature or an audio file.

For example, in one aspect, the inventive method 100 may include delivering a package to the recipient, picking up at least one of a recipient voice and a recipient image using a handheld device, the recipient voice and/or recipient image being transduced into an electrical identification signal using the handheld device, inputting at least one of delivery data and recipient data into the handheld device, and storing at least one the delivery data, recipient data, and electrical identification signal in the handheld device.

Specifically, the courier delivery person's handheld device could include a digital camera (e.g., still photo or video camera), to record a photograph (e.g., video) of the recipient, and save it in the handheld device's memory as a JPEG, MPEG, PDF or TIFF file or other image storage format. Further, the inventive method 100 may incorporate the features and functions of the delivery method disclosed, for example, in PCT Application No. PCT/US02/13903, “Delivery System and Method Using Electronic Tags” of John Stevens, et al., filed on May 3, 2002, assigned to the present assignee and incorporated by reference herein.

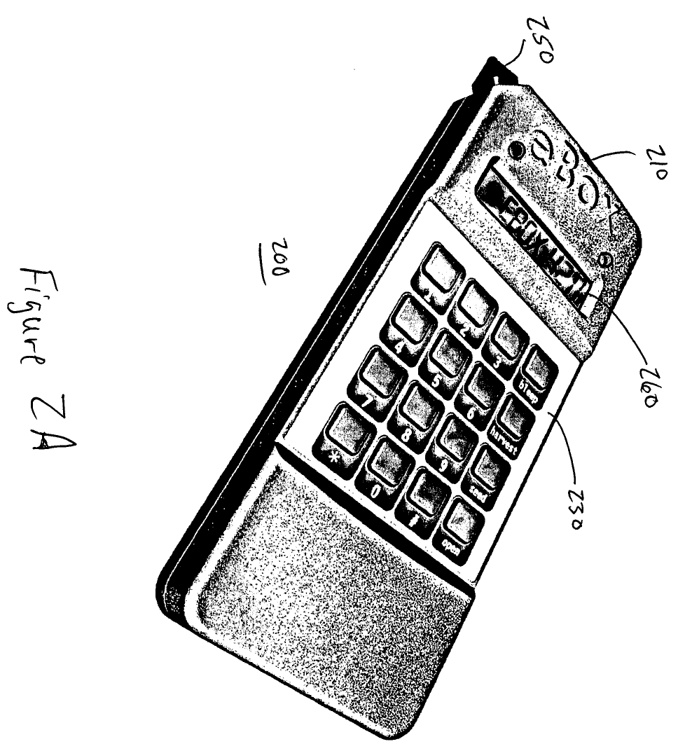

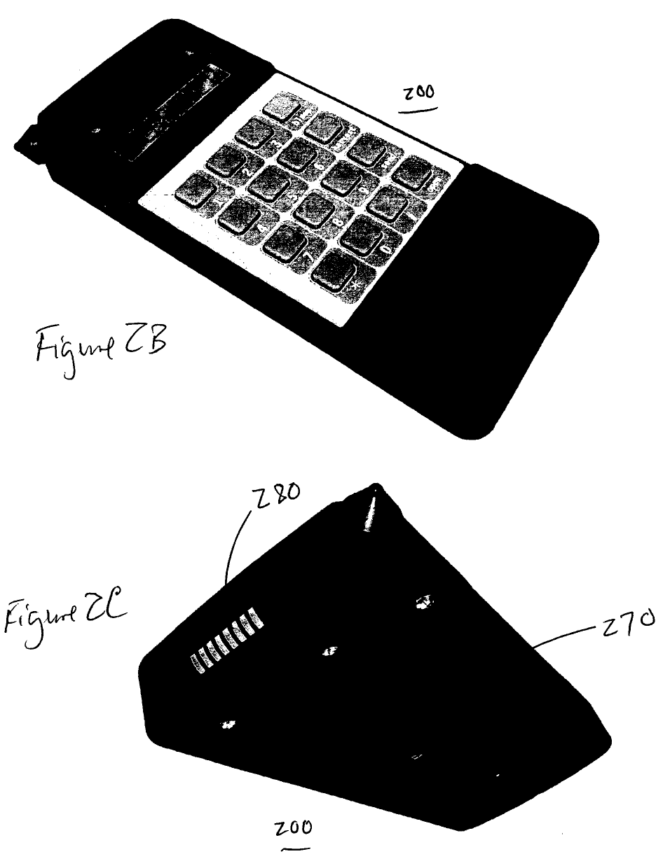

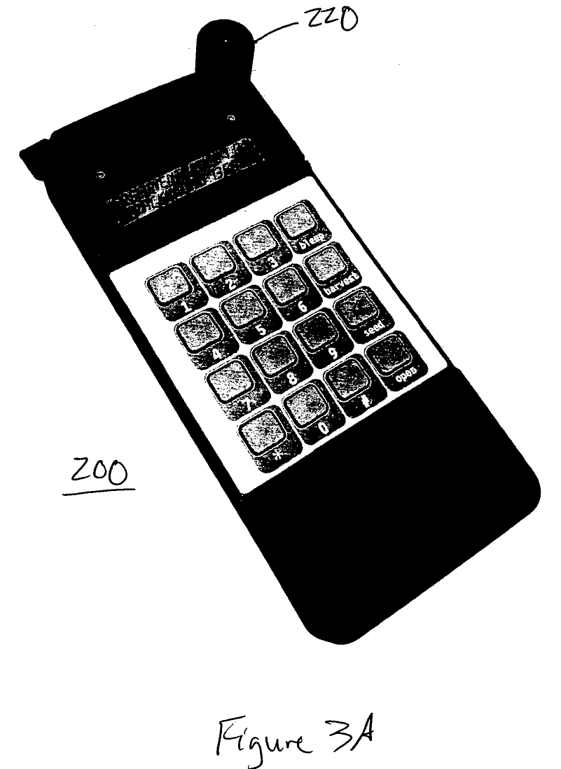

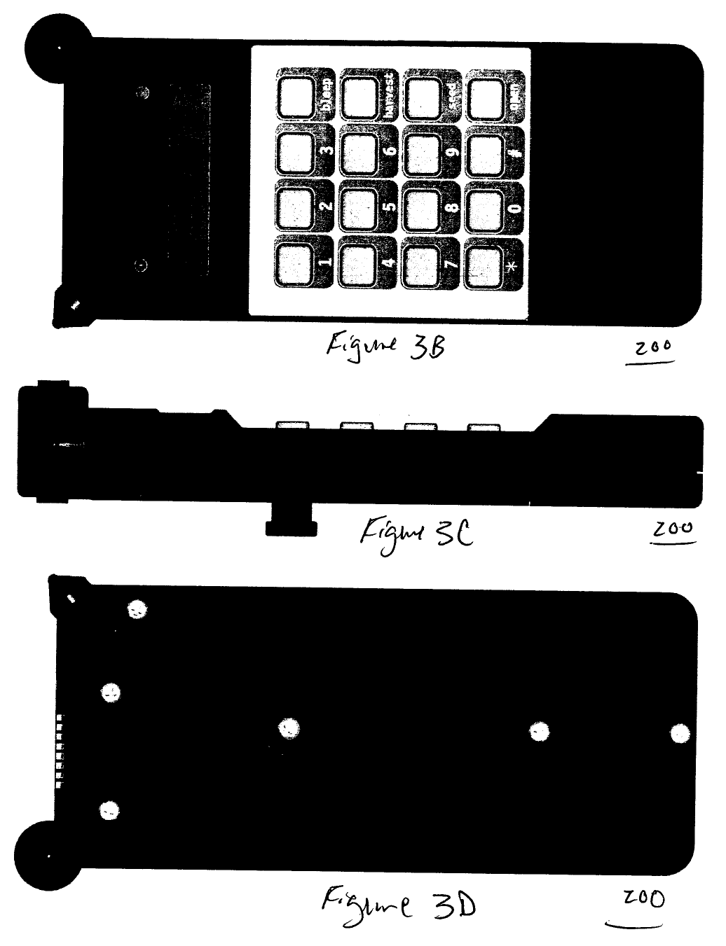

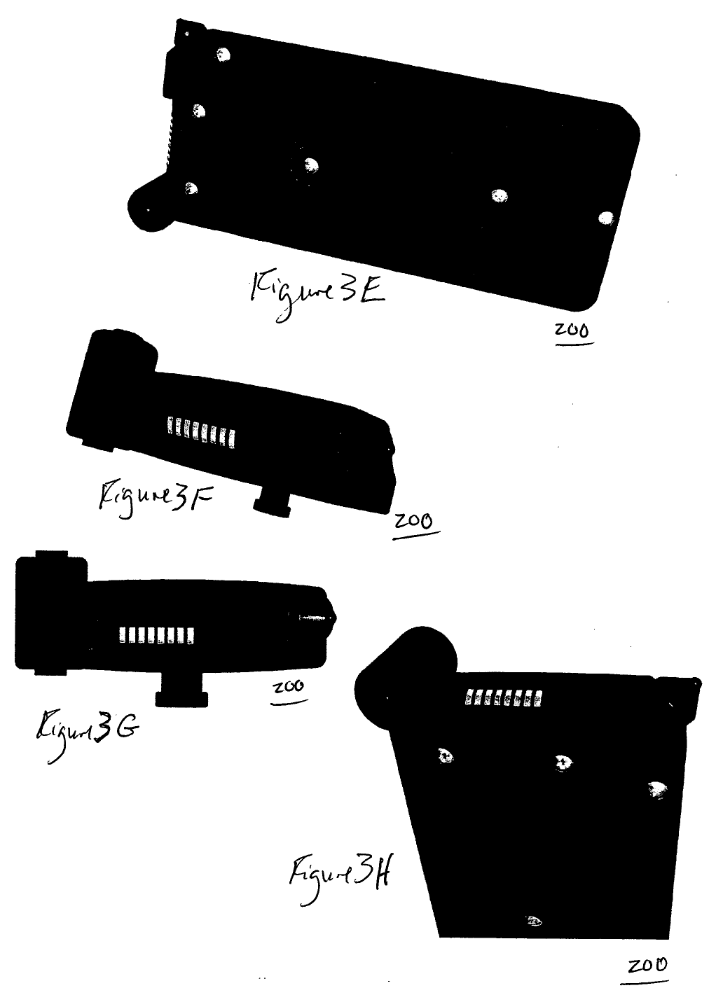

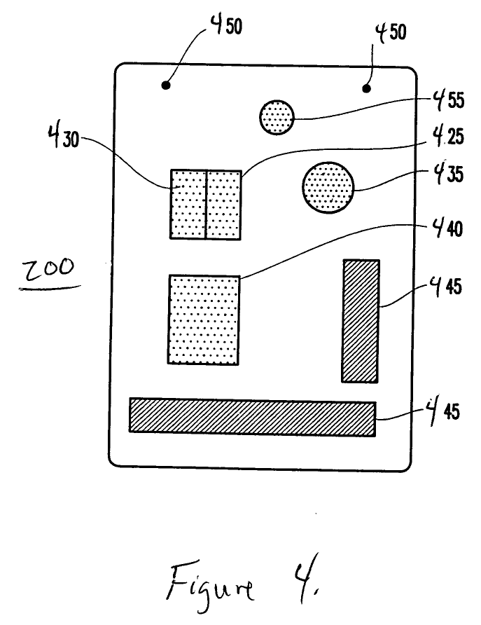

Referring again to the drawings, FIGS. 2A-2C and FIGS. 3A-3H illustrate an inventive device 200 (e.g., a handheld device) that may be used to identify a courier package recipient and verify delivery according to the present invention. The inventive device includes an identification pickup device 210, 220.

Specifically, FIGS. 2A-2C illustrate a device 200 which includes an audio pickup device 210 such as a microphone. FIGS. 3A-3H illustrate a device 200 which includes an image pickup device 220 such as a charge coupled device (CCD). It should be understood that the device may include both an audio pickup device 210 and an image pickup device 220. Moreover, the characteristics (e.g., location, size, etc.) of the audio pickup device 210 and the image pickup device 220 illustrated herein should not be considered limiting. For example, these devices 210, 220 may have any size and may be located at practically any location on the device 200.

Specifically, the audio pickup device may include a microphone and the digital identification signal may include a digital audio signal. Further, the identification pickup device may include an image pickup device and the digital identification signal may include a digital image signal.

Further, the device 200 may record the digital identification signal or may wirelessly transmit the signal so that it is remote recorded. Thus, for example, the device 200 may include an audio recorder for recording the audio signal, and/or the CCD may be a part of a digital (e.g., still image or video) camera included in the device 200 for recording the image signal.

Referring again to FIGS. 2A-2C and FIGS. 3A-3H, in an exemplary embodiment, the inventive device includes a microphone 210 for picking up a recipient voice and transducing said recipient voice into an electrical voice signal, and/or an image pickup device 220 (e.g., a camera) for picking up a recipient image and transducing said image into an electrical image signal.

The device 200 also includes an input device 230 (e.g., keypad) for inputting delivery data (e.g., and recipient data) into said device. Further, the identification pickup device and the input device may include the same device. That is, the courier may use the identification pickup device to pickup the recipient's identification, and also to input the delivery data. Thus, for example, the courier may input the delivery data into the device by simply speaking into the device. Thus, the delivery data may be input in the same manner as the recipient's identification.

Further, the device 200 includes a memory device (e.g., contained within the housing of the device 200) for storing the identification signal in the form of identification data. The memory device may also store the delivery data (e.g., and recipient data). The handheld device 200 may also include a barcode reader 250 and a display panel 260 (e.g., LED display panel).

Further, as shown, for example, in FIG. 2C, the handheld device 200 may also include a fastening device 270 which allows the device 200 to be easily fastened (e.g., removably fastened) to a belt of the delivery person. The device 200 may also include a port 280 to facilitate the uploading or downloading of information (e.g., data, instructions, etc.) to and from the device. For example, after making deliveries, the device 200 may be set into a cradle-type device having an interface for engaging the port 280 for allowing the easy transfer of information to and from the device.

Further, the inventive device 200 may be used as a multi-functional device which is used by a courier, for example, for recording, manipulating and displaying data (e.g., delivery information). For example, the inventive device 200 may incorporate the features and functions of an electronic tag (e.g., electronic module) or access card which are disclosed in PCT Application No. PCT/US02/13903 “Delivery System and Method Using Electronic Tags”.

For instance, the inventive device 200 may also be used to open a drop box so that the delivery person can make an unattended delivery to a destination address. Further, the handheld device 200 may be used to remove a package that has been delivered to the drop box.

More specifically, as shown in FIG. 4, like the electronic tag (e.g., electronic module) and access card, the device 200 may include a processor 425 (e.g., a fixed programmed multi-bit microprocessor such as a four-bit processor), a memory device 430 (e.g., read only memory (ROM), random access memory (RAM), etc.) and a power source 435 (e.g., a battery, lithium battery, etc.). The handheld device 200 may also include an activating device 455 (e.g., button) for activating any one or more of the functions of the handheld device 200.

The handheld device 200 may also include a transceiver 440 (e.g., a transmitter/ receiver, custom two-way communication analog chip, etc.) and an antenna 445 (e.g., two ferrite antennas) to transmit and receive data over a short range link. The power source (e.g., battery) preferably has a long service life (e.g., over five years) for performing many (e.g., several thousand) transactions. Further, the handheld device 200 may optionally include a signaling device 450 (e.g., light-emitting device (e.g., one or two light emitting diodes (LEDs)) or an audible signaling device).

For instance, similar to the electronic tag disclosed in PCT Application No. PCT/US02/13903, “Delivery System and Method Using Electronic Tags”. Furthermore, the drop box and the handheld device 200 may be programmable so that the owner can selectively change the identification number which unlocks the drop box.

The handheld device 200 may also be interrogated to harvest data such as the recipient identification data, package delivery time, date and location. In addition, the handheld device 200 may be used to automatically cause an electronic mail message including such harvested data (e.g., recipient identification data, delivery data, etc.) to be transmitted, for example, to the sender (and/or the receiver) of the package. The handheld device 200 may then be set aside for reuse.

In short, as shown in FIGS. 2A-2C and 3A-3H, the inventors have developed a Handheld Courier Device (commonly referred to as an “eBox Handheld”). The handheld device may include, for example, a keypad (e.g., numeric or alphanumeric) and some function keys, a barcode scanner (e.g., barcode reader), a display (e.g., liquid crystal display (LCD)), identification pickup device (e.g., microphone and/or camera), microprocessor and memory for storing digital audio and/or image files.

The inventive device 200 may also include a data port or Infra red (IR) data transfer port for transferring data (e.g., delivery data, identification data, etc.) to and from the handheld device 200. In addition to storing the package recipient's voice and bar code information., the handheld can store other conventional information. For example, the device may store the delivery person's name, shipping and delivery date, address information, shipper information, waybill and tracking numbers), customs and broker information.

In addition to the package recipient's voice, the handheld device 200 may also be used in unattended deliveries to an unattended delivery lockbox (e.g., drop box), such as those manufactured and developed by eBox Inc. Such a drop box is described, for example, in PCT Application No. PCT/US02/13903 “Delivery System and Method Using Electronic Tags”.

Accordingly, the inventive device 200 (e.g., a handheld device) could include functionality to allow it to harvest data from an eBox unattended drop box. (e.g., time opened, time locked, identity of person accessing box (e.g., who's access card opened drop box), personal identity number (PIN) of the person (e.g., identification using access device with numeric keypad), date, delivery time, and package information such as barcode, package tracking number, waybill number, etc.).

A key protection issue involves protecting the hardware, and the concept of online WAV file with ID graph, Fast Fourier Transform (FFT) Algorithm or other spectrum hash of voice print online. This is a very low cost approach to making handheld terminals compared to conventional handheld terminal devices used today in the Courier industry (e.g., FedEx, UPS, Purolator).

The inventive device 200 incorporates an audio ID or voice file as the next undeniable Proof of Delivery. Further, the voice file may be cross-referenced to the package's convention delivery information (waybill, tracking number, addressee, sender,) to confirm proof of delivery.

Specifically, the concept of the inventive device 200 may involve, for example, an audio WAV file as ID for deliveries. This functionality is more user-friendly and provides greater more specific information than relying, for example, on the Courier to accurately type the recipient's name on the handheld device 200 (as is done on prior art devices) or relying on the consistency and legibility of the recipient's signature on the signature screen as is done on conventional devices.

Further, audio ID is even better than current prior art methods using writeable screens (e.g., liquid crystal display (LCD) screens). Such methods are currently used by companies such as FedEx, UPS, Purolator and Canada Post to identify package recipients.

One serious problem with such conventional methods and devices is that they are unreliable. For instance, some delivery personnel type it in and some do not, or fail to type it in accurately and make typing or spelling mistakes. Further, signatures may not be recorded properly on the LCD, or may not be consistent (e.g., a person may sign differently each time he signs for a package), or may just be undecipherable or illegible. Moreover, such conventional methods are unable to provide for a secure delivery, such as may be needed with more sensitive or confidential packages or documentation.

With the inventive device 200 and method 100, on the other hand, the problems of the conventional systems may be eliminated. For example, the inventive device 200 may be used to make a secure delivery, such as may be needed with more sensitive or confidential packages or documentation. For instance, the digital identification signal (e.g., the digital identification data such as audio or video data) can be used almost instantly by the sender to verify that the recipient is the proper recipient. Moreover, since the recipient knows that his image or voice can be analyzed with the inventive device 200, a thief is less likely to attempt to steal a package or documentation meant for another recipient.

Thus, using the inventive device 200 a delivery person can quickly and easily make a delivery and provide identification information for the recipient and proof of delivery. For example, the delivery person (e.g., delivery driver) may carry an in-truck signature sheet. Such signature sheets customarily include, for example, barcodes on one side, two boxes (one box for a signature, and one box for the printed name). There may be 20 entries per page and each page may include 2 Barcodes (2 and 3) with “SIG45 67899” SIG indicates this is a signature code, 45 is driver code and 67899 is a serial number.

For example, using the inventive device 200 the delivery person may scan a package barcode so that the SAC LCD may read “get signature”. Further, the recipient of the package prints and signs name on next empty spot on sheet. The driver may, thus, scan signature ID barcode to right of printed name and signature (e.g., the handheld device may display instructions to delivery person to tell him what to do).

Alternatively, instead of inputting data using a barcode scanner or alphanumeric keypad, the delivery person may also use the identification pickup device to input such information. That is, the delivery person may speak into a microphone on the handheld device to input information such as the date, time and location of the package.

Further, unlike conventional systems, with the inventive device 200, the delivery person may record the recipient's voice, for example, on an audio file. For instance, the delivery person may ask the recipient to state his or her name, location/address, date, time, and employer. For example, the recipient may state “my name is John Smith, I work for Acme Corp., I am receiving this package in the mailroom at 234 York Street.” Therefore, the recipient's statement may be recorded, for example, as an audio file recorded in the memory of the handheld device 200.

At the end of workday, the data from the handheld device may be dumped into the courier's computer system. This may be accomplished quickly and easily using scans (e.g., by infrared (IR) data transfer or by cradle with hard-wire connection) or wirelessly.

Further, the signature pages may be faxed to the courier's network (or alternatively digitally scanned and sent to the courier's network). Thus, the scanned images of the recipient's signature and the recipient's printed name may be extracted for a delivered package, and transferred (e.g., via Local Access Network (LAN) line, the Internet, or wireless link) to a database maintained, for example, by the courier (e.g., the courier company or delivery company). For example, the information may be transferred to a database accessible by a server servicing the courier's web site. Therefore, the package sender may go the courier company's website and quickly and easily confirm that the package to delivered to the proper recipient.

The recipient's identification data (e.g., audio file) may go into same database as a WAV file. The database of such identification data is accessible online. However, the database is secure so that it may only be accessible, for example, by customers and customer support. For example, a security code may be required to access the identification database.

As one additional optional feature, the recipient's identification information (e.g., audio file) can be analyzed using a mathematical processing method, such as the Fourier spectrum. This information can be accessible next to a WAV (wave) file, and can be used to create a voice print to verify that the recipient “Voice ID signature” is real and correct. That is, the information can be analyzed to confirm that the package recipient was the intended recipient.

More specifically, an authorized person (e.g., customer, or customer service) can click online to the Courier's website, click the button “Track package” and see a list of important and valuable information after entering some package information. Such information may include, for example, the tracking number, package ID, time, date, addresses of sender and recipient, shipping route, printed images of signature, and signature image.

Moreover, the sender may be able to access the recipient's identification data. For example, the sender may access the WAV file which contains the statement of the recipient and which was recorded by the delivery person. Therefore, the recipient may listen to the recipient's statement (e.g., “my name is John Smith, I work for Acme Corp., I am receiving this package in the Mailroom and 234 York Street”). The recipient may also access the WAV ID (e.g., a bar graph with maybe 20 bars of a Fourier Transform processing of the WAV file (or some other analytical characterization of the WAV file). Thus, the recipient may compare the WAV ID with a standard (e.g., a WAV ID which was recorded during a previous delivery to the subject recipient) in order to confirm the identification of the recipient.

In addition, with the present invention, the sender may even request “real time” identification of recipient and proof of delivery. In other words, the delivery person may deliver the package to the recipient's address and then record the recipient's voice or image which may be wirelessly transmitted to the courier's computer system (e.g., database). The sender may access the database (e.g., via the courier's website on the Internet) and download the voice or image recording to verify that the recipient is or is not proper. Further, the sender could input a “go/no go” response to the delivery person (e.g., via the courier's website) to direct the delivery person in real time as to whether the recipient is or is not a proper recipient.

Therefore, the inventive device 200 has many advantages over conventional devices. For instance, with the inventive device 200, there is no need to waste a delivery person's time typing in names etc. In addition, recipients will be extra vigilant when receiving packages. In other words, the inventive device 200 will promote higher mailroom reliability and ownership of received packages. In addition, the voice and/or image recording (e.g., WAV file or JPEG, MPEG, PDF, or TIFF file) can be reproduced and compared with historical samples in database to show that the proper recipient (e.g., the same person) received the package.

Further, the present invention may also include a programmable storage medium tangibly embodying a program of machine-readable instructions executable by a digital processing apparatus to perform the inventive method.

Further, it should be noted that the present invention is not limited to deliveries but may be used in any circumstance where the identification of a package recipient is involved. For example, the invention may be used when a person walks into a courier's building to pickup a package. Further, the inventive device does not have to be a handheld device or a portable device but may include a device which is located at the courier's building for use when a customer comes to pickup a package.

With its unique and novel aspects, the present invention provides a method and device for identifying a courier package recipient and verifying delivery which may utilize an electronic (e.g., voice and/or image) recording. Specifically, the present invention provide a more reliable way of identifying a package recipient and/or providing proof of delivery.

While preferred embodiments of the present invention has been described above, it should be understood that the embodiments have been provided as examples only. Thus, those skilled in the art will recognize that the invention can be practiced with modification within the spirit and scope of the appended claims.

It should be noted that the term “package” should be interpreted to mean letter, document, box, bag or any other item which may be delivered to a person.

Further, Applicant's intent is to encompass the equivalents of all claim elements, and no amendment to any claim in the present application should be construed as a disclaimer of any interest in or right to an equivalent of any element or feature of the amended claim.

What we claim is:

1. A method for identifying a package recipient, said method comprising:
delivering a package to a recipient; and
recording at least one of said recipient's voice and said recipient's image.

2. The method according to claim 1, further comprising:
reproducing said recording in order to identify a package recipient.

3. The method according to claim 1, wherein said recipient's voice is recorded in a digital audio file.

4. The method according to claim 3, wherein said digital audio file comprises a digital audio file in a file format for storing waveform data.

5. The method according to claim 1, wherein said recipient's image is recorded in a digital image file.

6. The method according to claim 5, wherein said digital image file comprises one of a JPEG file, MPEG file, PDF file and TIFF file.

7. The method according to claim 1, wherein said image comprises one of a still image and a video image.

8. A method for identifying a package recipient, said method comprising:
generating a digital identification signal for said recipient using an identification pickup device;
inputting delivery data; and
storing said identification signal and said delivery data.

9. A device for identifying a package recipient, said device comprising:
an identification pickup device for generating a digital identification signal for said recipient;
an input device for inputting delivery data; and
a memory device for storing said identification signal and said delivery data.

10. The device according to claim 9, wherein said identification pickup device and said input device comprise the same device.

11. The device according to claim 9, wherein said identification pickup device comprises one of an audio pickup device and an image pickup device.

12. The device according to claim 9, wherein said digital identification signal comprises one of a digital voice signal and a digital image signal.

13. The device according to claim 9, wherein said identification pickup device comprises a microphone and said digital identification signal comprises a digital audio signal.

14. The device according to claim 9, wherein said identification pickup device comprises an image pickup device and said digital identification signal comprises a digital image signal.

15. The device according to claim 9, further comprising:
a user switch for selectively activating or deactivating said identification pickup device.

16. The device according to claim 9, further comprising:
a display device for displaying a representation of said digital identification signal.

17. The device according to claim 9, further comprising:
a processor for processing data and instructions; and
a transceiver for wirelessly communicating said digital identification signal to a remote database.

18. The device according to claim 9, wherein said input device comprises an alphanumeric keypad.

19. The method according to claim 1, wherein said identifying a package recipient and providing proof of delivery is performed in real time.

20. A programmable storage medium tangibly embodying a program of machine-readable instructions executable by a digital processing apparatus to perform a method for identifying a package recipient, said method comprising:
generating a digital identification signal for said recipient using an identification pickup device;
inputting delivery data; and
storing said identification signal and said delivery data.
